(19) United States
(12) Patent Application Publication
(10) Pub. No.: US 2025/0141034 A1
(43) Pub. Date: May 1, 2025

(54) TRACTION BATTERY PACK FILTERING SYSTEM AND FILTERING METHOD

(71) Applicant: Ford Global Technologies, LLC, Dearborn, MI (US)

(72) Inventors: Ravi Jagdish Saripella, Farmington Hills, MI (US); Christopher Steven Baldwin, Royal Oak, MI (US); Brian Utley, Canton, MI (US)

(21) Appl. No.: 18/379,359

(22) Filed: Oct. 27, 2023

(51) Int. Cl. H01M 50/358; B01D 46/62; B60L 50/64; H01M 50/209; H01M 50/271; H01M 50/342

(52) U.S. Cl. CPC H01M 50/358; B01D 46/62; B60L 50/64; H01M 50/209; H01M 50/271; H01M 50/3425; B01D 2267/40; B01D 2279/35; B01D 2279/45; H01M 2220/20

(57) ABSTRACT

A device may include an enclosure assembly providing an interior that houses at least one battery array. A device may include a pressure relief valve that communicates a flow of vent byproducts from the interior of the enclosure assembly when the pressure relief valve is in an open position. A device may include a filtering system having at least one first filter that filters the flow and at least one second filter that filters the flow, the first filter having a first permeability, the second filter having a second permeability that is different than the first permeability.

### TECHNICAL FIELD

This disclosure relates generally to electrified vehicle traction battery packs and, more particularly, to filtering systems for filtering battery vent byproducts.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

### SUMMARY

In some aspects, the techniques described herein relate to a traction battery assembly, including: an enclosure assembly providing an interior that houses at least one battery array; a pressure relief valve that communicates a flow of vent byproducts from the interior of the enclosure assembly when the pressure relief valve is in an open position; and a filtering system having at least one first filter that filters the flow and at least one second filter that filters the flow, the first filter having a first permeability, the second filter having a second permeability that is different than the first permeability.

In some aspects, the techniques described herein relate to a traction battery assembly, further including a vent duct that is configured to communicate the flow from the pressure relief valve.

In some aspects, the techniques described herein relate to a traction battery assembly, wherein the vent duct includes an inlet end portion that receives the flow from the pressure relief valve and an outlet end portion that discharges the flow outside the interior of the enclosure assembly, the first filter adjacent the inlet end portion, the second filter adjacent the outlet end portion.

In some aspects, the techniques described herein relate to a traction battery assembly, wherein the first permeability of the first filter is greater than the second permeability of the second filter.

In some aspects, the techniques described herein relate to a traction battery assembly, wherein the first filter, the second filter, and the vent duct are outside the interior of the enclosure assembly.

In some aspects, the techniques described herein relate to a traction battery assembly, wherein the first filter and the second filter span across an inner diameter of the vent duct.

In some aspects, the techniques described herein relate to a traction battery assembly, wherein the first filter and the second filter are arranged within the interior between the at least one battery array and the vent, such that the flow passes through the first filter and the second filter before the flow passes through the pressure relief valve.

In some aspects, the techniques described herein relate to a traction battery assembly, wherein the enclosure assembly includes a lid and a tray, and the first filter and the second filter span between the lid and the tray.

In some aspects, the techniques described herein relate to a traction battery assembly, wherein the first permeability of the first filter is greater than the second permeability of the second filter.

In some aspects, the techniques described herein relate to a traction battery assembly, wherein the pressure relief valve includes an inlet end portion that receives the flow from the interior of the enclosure assembly and an outlet end portion that discharges the flow outside the interior of the enclosure assembly, the first filter adjacent the inlet end portion, the second filter adjacent the inlet end portion.

In some aspects, the techniques described herein relate to a traction battery assembly, wherein the first permeability of the first filter is greater than the second permeability of the second filter.

In some aspects, the techniques described herein relate to a traction battery assembly. wherein the pressure relief valve includes an inlet end portion that receives the flow from the interior of the enclosure assembly and an outlet end portion that discharges the flow outside the interior of the enclosure assembly, the first filter and the second filter adjacent the inlet end portion.

In some aspects, the techniques described herein relate to a traction battery assembly, wherein the first permeability of the first filter is greater than the second permeability of the second filter.

In some aspects, the techniques described herein relate to a traction battery assembly, wherein the first permeability of the first filter is configured to block particles of a first size within the flow and the second permeability of the second filter is configured to block particles of a second, different size within the flow.

In some aspects, the techniques described herein relate to a traction battery assembly venting method, including: communicating a flow of vent byproducts from an interior of an enclosure assembly that houses at least one battery array through a filter system that filters the flow, the filter system having at least one first filter having a first permeability and at least one second filter having a second, different permeability.

In some aspects, the techniques described herein relate to a method, wherein the flow is filtered through the filter system after the flow is communicated through a pressure relief valve that communicates the flow from the interior of the enclosure assembly.

In some aspects, the techniques described herein relate to a method, wherein the flow is filtered through the filter system before the flow is communicated through a pressure relief valve that communicates the flow from the interior of the enclosure assembly.

In some aspects, the techniques described herein relate to a method, wherein the pressure relief valve includes an inlet end portion that receives the flow from within the enclosure assembly and an outlet end portion that discharges the flow outside the enclosure assembly, the first filter adjacent the inlet end portion, the second filter adjacent the outlet end portion.

In some aspects, the techniques described herein relate to a method, wherein the pressure relief valve includes an inlet end portion that receives the flow from within the enclosure assembly and an outlet end portion that discharges the flow outside the enclosure assembly, the first filter and the second filter arranged adjacent the inlet end portion.

In some aspects, the techniques described herein relate to a traction battery assembly, wherein the first permeability of the first filter is configured to block particles of a first size within the flow and the second permeability of the second filter is configured to block particles of a second, different size within the flow.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack with a filtering system.

FIG. 2 is a perspective view of the traction battery pack of FIG. 1.

FIG. 3 illustrates a section view through the traction battery pack of FIG. 2.

FIG. 4 shows a close-up of the filter system from the traction battery pack of FIG. 3.

FIG. 5A is a close-up view of an exemplary filter from the filter system of FIG. 4.

FIG. 5B is a close-up view of another exemplary filter from the filter system of FIG. 4.

FIG. 6 illustrates a traction battery pack according to another exemplary aspect of the present disclosure.

FIG. 7 shows a close-up of the filter system from the traction battery pack of FIG. 6.

FIG. 8 illustrates a traction battery pack according to yet another exemplary aspect of the present disclosure.

FIG. 9A shows a close-up of the filter system from the traction battery pack of FIG. 8.

FIG. 9B shows a close-up of a variation of the filter system from the traction battery pack of FIG. 8.

### DETAILED DESCRIPTION

This disclosure relates generally to filtering systems for traction battery packs. The filtering systems can be used to filter a flow of vent byproducts (e.g., gases and/or effluent particulates) during thermal events. In an example, a filtering system includes at least one first filter and at least one second filter that are each configured to filter the flow of vent byproducts prior to the vent byproduct being exhausted from the traction battery pack. The first filter may have a first permeability and the second filter may have a second permeability that is different than the first permeability. These and other features are discussed in greater detail in the following paragraphs of this detailed description.

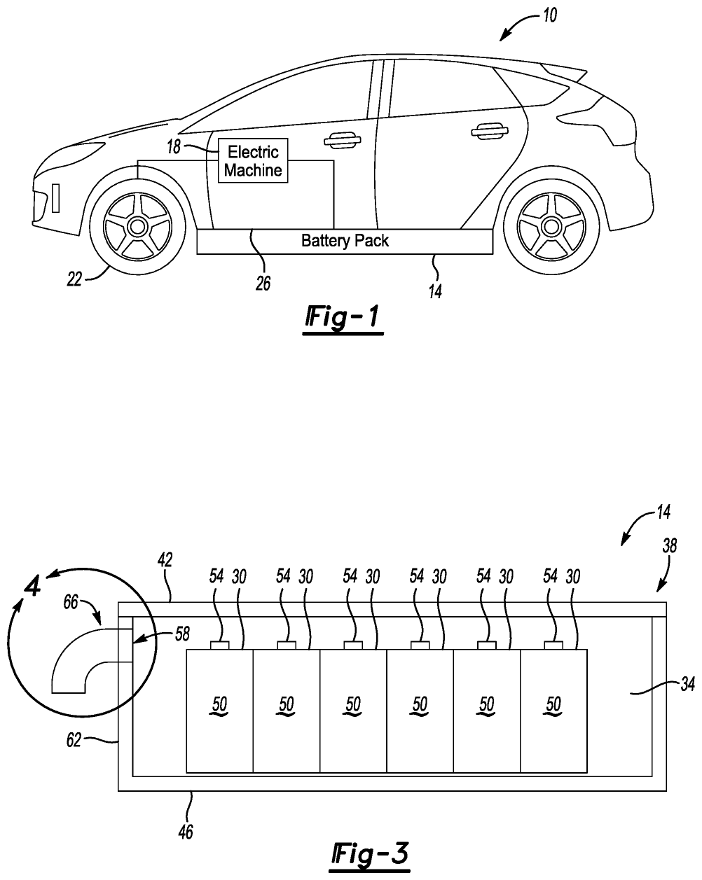

With reference to FIG. 1, an electrified vehicle 10 includes a traction battery pack 14, an electric machine 18, and wheels 22. The traction battery pack 14 powers the electric machine 18, which converts electric power to torque to drive the wheels 22.

The example electrified vehicle 10 is an all-electric vehicle. In other examples, the electrified vehicle 10 is a hybrid electric vehicle, which selectively drives wheels using torque provided by an internal combustion engine instead, or in addition to, an electric machine. Generally, the electrified vehicle 10 could be any type of vehicle having a traction battery pack.

In the example of FIG. 1, the traction battery pack 14 is secured to an underbody 26 of the electrified vehicle 10. However, the traction battery pack 14 could be located elsewhere on the electrified vehicle 10 in other examples.

Although a specific component relationship is illustrated in the figures of this disclosure, the illustrations are not intended to limit this disclosure. The placement and orientation of the various components of the electrified vehicle 10 are shown schematically and could vary within the scope of this disclosure.

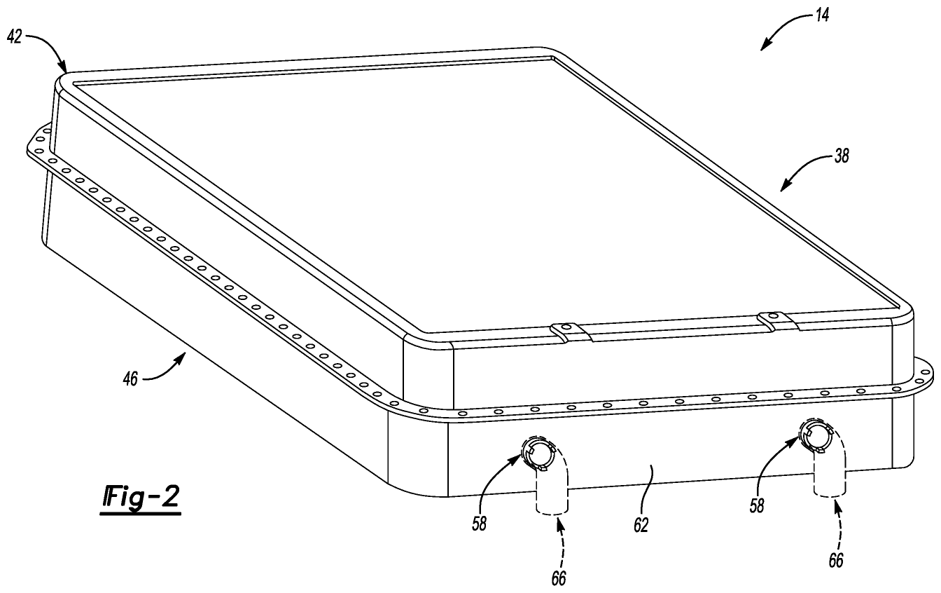

With reference to FIGS. 2 and 3, the traction battery pack 14 includes one or more battery arrays 30 held within an interior area 34 provided by an enclosure assembly 38. The battery arrays 30 are capable of outputting electrical power to power the electric machine 18 and/or other electrical loads of the electrified vehicle 10 (see FIG. 1).

The enclosure assembly 38 houses the battery arrays 30. The enclosure assembly 38 includes a cover 42 and a tray 46. The cover 42 can be secured (e.g., bolted, welded, adhered, etc.) to the tray 46 to provide the interior area 34. The cover 42 and tray 46 can be polymer-based. Alternatively, the cover 42, the tray 46, or both can be a metal or metal alloy.

Each of the example battery arrays 30 includes a plurality of battery cells 50 that are stacked side-by-side.

In this example, the battery cells 50 each include a vent 54. The battery pack 14 can experience a thermal event when pressure within one of the battery cells 50 increases due to, for example, over-charging conditions or over-discharging conditions. The pressure increase can cause the vent 54 to rupture, which releases a flow of vent byproducts into the interior area 34. The vent byproducts can include gases, effluent particles, and constituent materials such as internal pieces of the battery cells and internal pieces of the traction battery pack, for example.

The traction battery pack 14 is equipped with features for venting the vent byproducts from the enclosure assembly 38 to an area outside the traction battery pack 14.

Referring to FIGS. 2-5B, the traction battery pack 14 includes at least one pressure relief valve 58. The pressure relief valve 58 is disposed in a wall 62 of the enclosure assembly 38. The pressure relief valve 58 can be disposed in the cover 42, the tray 46, or both. The pressure relief valve 58 could be secured to the enclosure assembly 38 with a twist-lock style connection.

The pressure relief valve 58 is configured to transition from a closed position and an open position when pressure within the interior area 34 increases due to one or more battery cells 50 venting during a thermal event. When in the closed position, the pressure relief valve 58 blocks flow from the interior area 34. When in the open position, the pressure relief valve 58 permits the flow of vent byproducts to move from the interior area 34 to an area outside the traction battery pack 14.

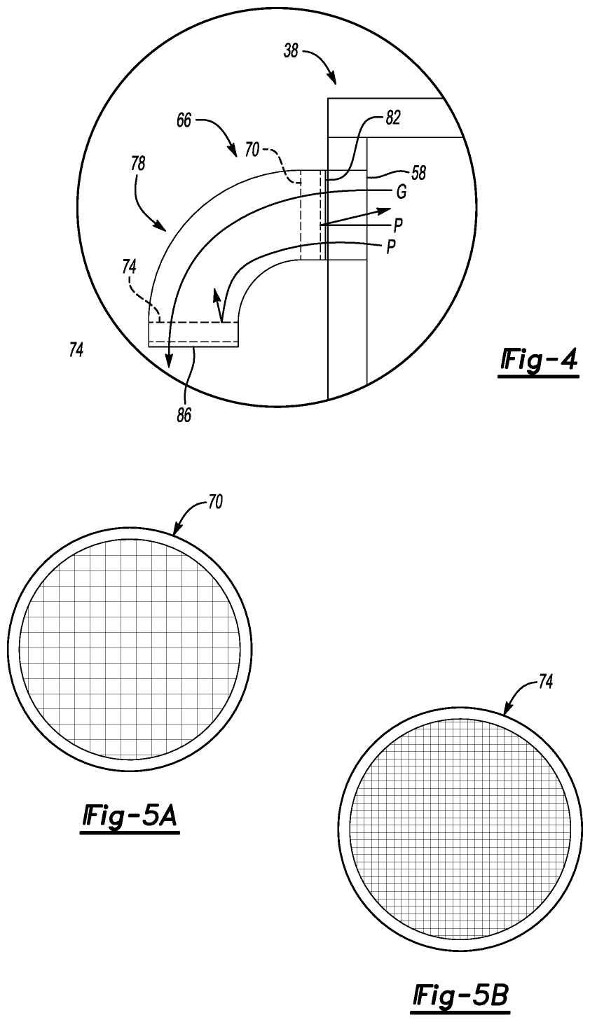

A filter system 66 is provided for filtering the flow of vent byproducts that pass through the pressure relief valve 58. In the example of FIG. 4, the filter system 66 is outside of the enclosure assembly 38 and includes a first filter 70 and a second filter 74 disposed within a vent duct 78. In other examples, the filter system 66 could include any number of filters, each having a different permeability, as discussed further below. The vent duct 78 communicates a filtered flow of vent byproducts from the pressure relief valve 58 to an area outside the enclosure assembly 38.

The example vent duct 78 is mounted (e.g., welded, bolted, etc.) to the wall 62 of the enclosure assembly 38. The vent duct 78 can direct the flow of vent byproducts from the pressure relief valve 58 to a location outside the enclosure assembly 38.

In one example, the vent duct 78 is cylindrical, and the first filter 70 and the second filter 74 span across an inner diameter of the vent duct 78.

The first filter 70 is adjacent to an inlet end portion 82 of the vent duct 78. The inlet end portion 82 receives the flow of vent byproducts from the pressure relief valve 58. The first filter 70 can be a permeable sheet having a first permeability (see FIG. 5A). A flow of gas G vented from the battery cells 50 can move through the first filter 70 to an area outside the enclosure assembly 38. The first filter 70 can block a flow of particulates P of a first size, thereby confining particulates of the first size to the interior area 34 of the enclosure assembly 38.

The second filter 74 is adjacent to an outlet end portion 86 of the vent duct 78. The outlet end portion 86 discharges the flow of vent byproducts from the pressure relief valve 58 to an area outside the enclosure assembly 38. The second filter 74 can be a permeable sheet having a second permeability that is different than the first permeability of the first filter 70 (see FIG. 5B). The flow of gas G vented from the battery cells 50 can move through the second filter 74 to an area outside the enclosure assembly 38. The second filter 74 can block a flow of particulates P of a second size, thereby confining particulates of the second size to the vent duct 78, the interior area 34 of the enclosure assembly 38, or both.

During typical conditions for the battery pack 14 when there is no thermal event causing battery cells 50 to vent, the second filter 74 can also block environmental particulates from moving into the interior area 34 from outside the enclosure assembly 38. The second filter 74 can also prevent animals, such as rodents and insects, from entering the vent duct 78.

The first filter 70 and the second filter 74 can also provide a heat sink for the gas G vented through the vent duct 78. For instance, the first filter 70 and the second filter 74 can be made of a high temperature resistant material including steel and ceramic materials.

In one example, the first permeability is greater than the second permeability, such that the first size of particulates P blocked by the first filter 70 is greater than the second size of particulates P blocked by the second filter 74.

In this disclosure, like reference numerals designate like elements where appropriate and reference numerals with the addition of one-hundred or multiples thereof designate modified elements that are understood to incorporate the same features and benefits of the corresponding elements.

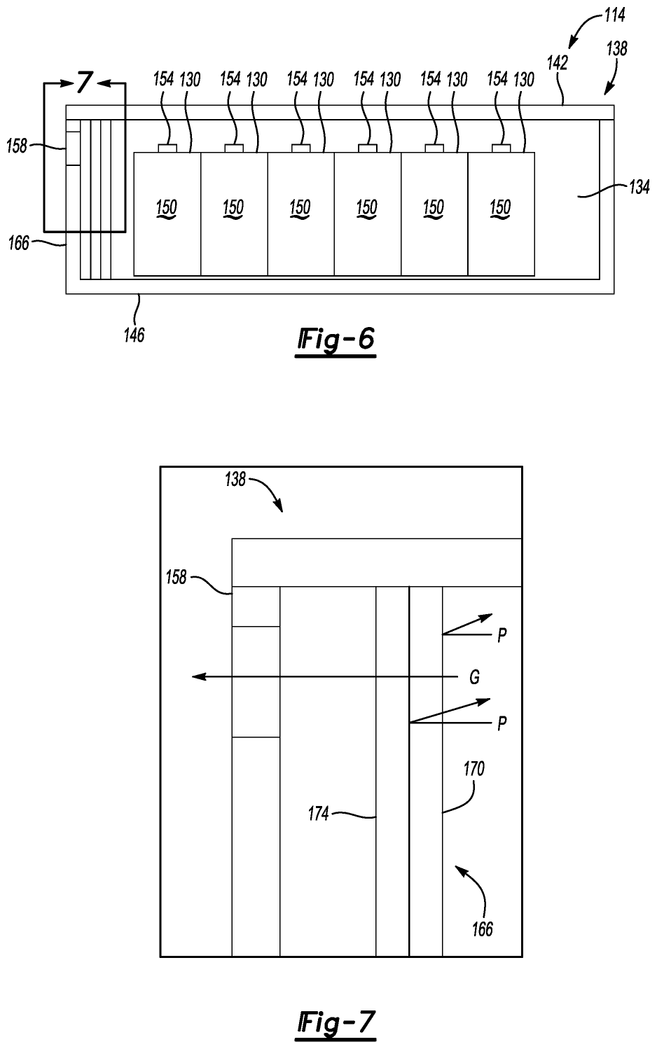

FIGS. 6 and 7 illustrate another exemplary traction battery pack 114. The traction battery pack 114 includes one or more battery arrays 130 held within an interior area 134 provided by an enclosure assembly 138. Each of the battery arrays 130 includes a plurality of battery cells 150 having a vent 154 that discharges vent byproducts. The traction battery pack 114 includes at least one pressure relief valve 158 that is movable from a closed position and an open position after certain thermal events of the traction battery pack 114 to communicate a flow of vent byproducts vented from the battery cells 150. The traction battery pack 114 includes a filter system 166 for filtering the flow of vent byproducts when the pressure relief valve 158 is in the open position. In this example, the filter system 166 is configured to at least partially filter the flow of vent byproducts before the flow of vent byproducts is passed through the pressure relief valve 158.

The filter system 166 includes a first filter 170 and a second filter 174 arranged within the interior area 134 of the enclosure assembly 138 between the battery cells 150 and the pressure relief valve 158. The first filter 170 and the second filter 174 span between a lid 142 and a tray 146 of the enclosure assembly 138. The first filter 170 and the second filter 174 could additionally or alternatively span between opposed sidewalls (not shown) of the enclosure assembly 138 in some examples.

The first filter 170 is a permeable sheet having a first permeability that permits a flow of gas G vented from the battery cells 150 to the pressure relief valve 158, while blocking a flow of particulates P of a first size vented from the battery cells 150. This confines particulates P of the first size to the interior area 134 of the enclosure assembly 138.

The second filter 174 is a permeable sheet having a second permeability that is different than the first permeability. The second permeability permits the flow of gas G vented from the battery cells 150 to the pressure relief valve 158, and further blocks a flow of particulates P of a second size vented from the battery cells 150. This confines particulates P of the second size to the interior area 134 of the enclosure assembly 138.

In one example, the first permeability is greater than the second permeability, such that the first size of particulates P blocked by the first filter 170 is greater than the second size of particulates P blocked by the second filter 174.

The first filter 170 and the second filter 174 are directly adjacent to each other in this example. The first filter 170 and the second filter 174 could be attached. In other examples, the first filter 170 and the second filter 174 can be spaced apart from each other.

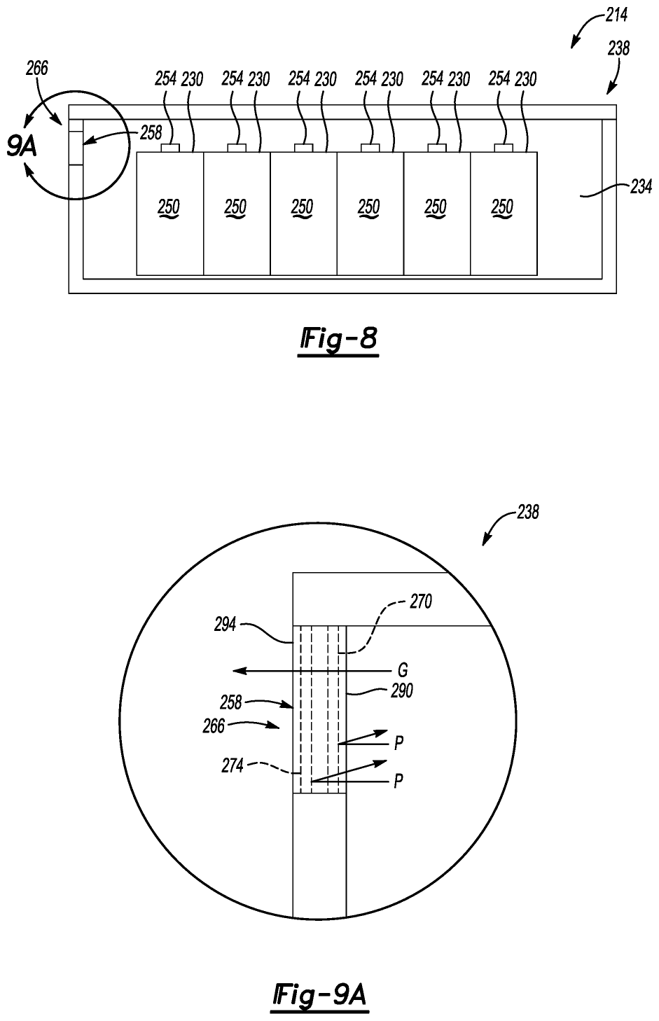

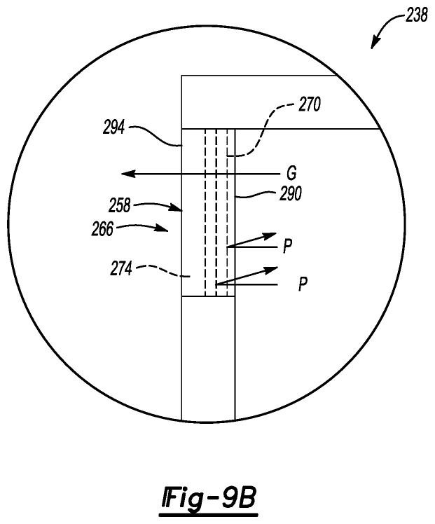

FIGS. 8, 9A, and 9B illustrate another exemplary traction battery pack 214. The traction battery pack 214 includes one or more battery arrays 230 held within an interior area 234 provided by an enclosure assembly 238. Each of the battery arrays 230 includes a plurality of battery cells 250 having a vent 254 that discharges vent byproducts. The traction battery pack 214 includes at least one pressure relief valve 258 that is movable from a closed position and an open position after certain thermal events of the traction battery pack 214 to communicate a flow of vent byproducts from the battery cells 250. The traction battery pack 214 includes a filter system 266 for filtering a flow of vent byproducts vented from the battery cells 250 when the pressure relief valve 258 is in the open position. In this example, the filter system 266 is configured to filter the flow of vent byproducts from the battery cells 250 as the flow of vent byproducts is passed through the pressure relief valve 258.

The filter system 266 includes a first filter 270 and a second filter 274 that are disposed within the pressure relief valve 258. The first filter 270 is arranged adjacent to an inlet end portion 290 of the pressure relief valve 258 that receives the flow of vent byproducts from the battery cells 250. The example first filter 270 is a permeable sheeting having a first permeability that permits a flow of gas G vented from the battery cells 250 to an area outside the enclosure assembly 238, and further blocks a flow of particulates P of a first size vented from the battery cells 250. This confines particulates P of the first size to the interior area 234 of the enclosure assembly 238.

The second filter 274 is arranged adjacent to an outlet end portion 294 of the pressure relief valve 258 that discharges the flow of vent byproducts from the pressure relief valve 58 to an area outside the enclosure assembly 238. The example second filter 274 is a permeable sheet having a second permeability that is different than the first permeability. The second permeability permits a flow of gas G vented from the battery cells 250 to an area outside the enclosure assembly 238, and further blocks a flow of particulates P of a second size vented from the battery cells 250. This confines particulates P of the second size to the interior area 234 of the enclosure assembly 238.

In the example embodiment of FIG. 9B, the first filter 270 and the second filter 274 are arranged adjacent to the inlet end portion 290 of the pressure relief valve 258. The first filter 270 and the second filter 274 are attached. In one example, the first permeability is greater than the second permeability, such that the first size of particulates P blocked by the first filter 270 is greater than the second size of particulates P blocked by the second filter 274.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery assembly, comprising:
an enclosure assembly providing an interior that houses at least one battery array;
a pressure relief valve that communicates a flow of vent byproducts from the interior of the enclosure assembly when the pressure relief valve is in an open position; and
a filtering system having at least one first filter that filters the flow and at least one second filter that filters the flow, the first filter having a first permeability, the second filter having a second permeability that is different than the first permeability.

2. The traction battery assembly of claim 1, further comprising a vent duct that is configured to communicate the flow from the pressure relief valve.

3. The traction battery assembly of claim 2, wherein the vent duct includes an inlet end portion that receives the flow from the pressure relief valve and an outlet end portion that discharges the flow outside the interior of the enclosure assembly, the first filter adjacent the inlet end portion, the second filter adjacent the outlet end portion.

4. The traction battery assembly of claim 3, wherein the first permeability of the first filter is greater than the second permeability of the second filter.

5. The traction battery assembly of claim 2, wherein the first filter, the second filter, and the vent duct are outside the interior of the enclosure assembly.

6. The traction battery assembly of claim 2, wherein the first filter and the second filter span across an inner diameter of the vent duct.

7. The traction battery assembly of claim 1, wherein the first filter and the second filter are arranged within the interior between the at least one battery array and the vent, such that the flow passes through the first filter and the second filter before the flow passes through the pressure relief valve.

8. The traction battery assembly of claim 7, wherein the enclosure assembly includes a lid and a tray, and the first filter and the second filter span between the lid and the tray.

9. The traction battery assembly of claim 7, wherein the first permeability of the first filter is greater than the second permeability of the second filter.

10. The traction battery assembly of claim 1, wherein the pressure relief valve includes an inlet end portion that receives the flow from the interior of the enclosure assembly and an outlet end portion that discharges the flow outside the interior of the enclosure assembly, the first filter adjacent the inlet end portion, the second filter adjacent the inlet end portion.

11. The traction battery assembly of claim 10, wherein the first permeability of the first filter is greater than the second permeability of the second filter.

12. The traction battery assembly of claim 1, wherein the pressure relief valve includes an inlet end portion that receives the flow from the interior of the enclosure assembly and an outlet end portion that discharges the flow outside the interior of the enclosure assembly, the first filter and the second filter adjacent the inlet end portion.

13. The traction battery assembly of claim 12, wherein the first permeability of the first filter is greater than the second permeability of the second filter.

14. The traction battery assembly of claim 1, wherein the first permeability of the first filter is configured to block particles of a first size within the flow and the second permeability of the second filter is configured to block particles of a second, different size within the flow.

15. A traction battery assembly venting method, comprising:
communicating a flow of vent byproducts from an interior of an enclosure assembly that houses at least one battery array through a filter system that filters the flow, the filter system having at least one first filter having a first permeability and at least one second filter having a second, different permeability.

16. The method of claim 15, wherein the flow is filtered through the filter system after the flow is communicated through a pressure relief valve that communicates the flow from the interior of the enclosure assembly.

17. The method of claim 15, wherein the flow is filtered through the filter system before the flow is communicated through a pressure relief valve that communicates the flow from the interior of the enclosure assembly.

18. The method of claim 17, wherein the pressure relief valve includes an inlet end portion that receives the flow from within the enclosure assembly and an outlet end portion that discharges the flow outside the enclosure assembly, the first filter adjacent the inlet end portion, the second filter adjacent the outlet end portion.

19. The method of claim 17, wherein the pressure relief valve includes an inlet end portion that receives the flow from within the enclosure assembly and an outlet end portion that discharges the flow outside the enclosure assembly, the first filter and the second filter arranged adjacent the inlet end portion.

20. The traction battery assembly of claim 15, wherein the first permeability of the first filter is configured to block particles of a first size within the flow and the second permeability of the second filter is configured to block particles of a second, different size within the flow.
